(19) United States
(12) Patent Application Publication
(10) Pub. No.: US 2025/0139823 A1
(43) Pub. Date: May 1, 2025

(54) DIGITAL FINGERPRINT FOR COMPONENT SERIALIZATION

(71) Applicant: Ethicon Endo-Surgery, Inc., Cincinnati, OH (US)

(72) Inventors: Chad S. Lape, Mason, OH (US); Javier Chavez Resendez, Ciudad Juárez, Chihuahua (MX); Jorge A. Dayer Carrillo, Wilmington (OH); Eduardo S. Delgado, Ciudad Juárez, Chihuahua (MX); Carlos I. Ramirez Martinez, Ciudad Juárez (MX)

(21) Appl. No.: 18/499,724

(22) Filed: Nov. 1, 2023

(51) Int. Cl. G06T 7/73; G06T 7/00

(52) U.S. Cl. CPC G06T 7/74; G06T 7/0004; G06T 2207/30164

(57) ABSTRACT

A method of tracking a portion of a surgical instrument includes imaging a surface discontinuity on the portion of the surgical instrument into a first digital image at a first station. The surface discontinuity is positioned within a gate scar formed from injection molding the portion of the surgical instrument. The method also includes processing the first digital image into a first processed image for tracking the portion of the surgical instrument.

### BACKGROUND

A variety of surgical instruments include an end effector having a blade element that vibrates at ultrasonic frequencies to cut and/or seal tissue (e.g., by denaturing proteins in tissue cells). These instruments include piezoelectric elements that convert electrical power into ultrasonic vibrations, which are communicated along an acoustic waveguide to the blade element. The precision of cutting and coagulation may be controlled by the surgeon's technique and adjusting the power level, blade edge, tissue traction and blade pressure.

Upon development of such precise surgical instruments, supply chains are established for each component part to be manufactured and assembled into one or more sub-assemblies, which may then be further assembled, eventually forming a final assembly of a completed surgical instrument to be disseminated through distribution channels and sent to an end customer for use. Supply chains for the manufacture and assembly of component parts are often quite complicated with many manufacturers in different respective locations, particularly in an increasingly globalized marketplace. Adding to this complexity, in one example, like component parts and/or associated assemblies tend to vary slightly due to manufacturing tolerances. These minor differences within manufacturing tolerances may affect performance of the surgical instrument unless further action is taken during the manufacturing process to accommodate these minor differences for more consistent performance among the completed surgical instruments. Tracking each unique component part and assembly throughout the supply chain thus enables these downstream adjustments for better, more consistent performance. Of course, this tracking may also benefit monitoring performance of each unique surgical instrument during its lifecycle and further enable targeted corrective actions that may be taken and tracked back upstream through the supply chain as desired.

In many instances, this tracking is facilitated by at least one party to the supply chain applying a unique, serialized identifier to each component part and even assemblies to be viewed and read by other parties. Unfortunately, adding this unique serialized identifier adds another, costly step to the manufacturing process and, in many instances, requires valuable surface area on the part to be dedicated to this serialization, which may negatively impact the appearance of the surgical instrument. This may be further complicated by small parts with unusual and/or inconsistent surface areas making application and viewing of serialized identifiers particularly difficult.

There is thus a need for a system and method for serializing one or more portions of an instrument, particularly a surgical instrument, that addresses present challenges and characteristics such as those discussed above. While several surgical instruments and systems have been made and used, it is believed that no one prior to the inventors has made or used the invention described in the appended claims.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a side elevational view of an exemplary surgical instrument having a handle assembly, a shaft assembly, an end effector, and an ultrasonic transducer assembly having a plurality of gate scars;

FIG. 2 depicts a partially exploded side elevational view of the surgical instrument of FIG. 1;

FIG. 3 depicts a perspective view of the ultrasonic transducer assembly of FIG. 1 with a transducer housing including a housing part;

FIG. 4 depicts a schematic perspective view of a runner system for injection molding the housing part of FIG. 3;

FIG. 5A depicts a perspective view of the housing part of FIG. 3 injection molded via a gate in a connected state therewith;

FIG. 5B depicts the perspective view of the housing part of FIG. 5A, but with gate in a disconnected state to reveal a gate scar;

FIG. 6 depicts a schematic perspective view of a registration system for serializing the housing part of FIG. 3 via the gate scar;

FIG. 7 depicts an enlarged, top plan view of the gate scar on the housing part of FIG. 3;

FIG. 8 depicts an example of a flowchart of a method of tracking a part during an assembly process; and

FIG. 9 depicts an exemplary flowchart of the method of tracking the part during the assembly process of FIG. 8.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

For clarity of disclosure, the terms “proximal” and “distal” are defined herein relative to a human or robotic operator of the surgical instrument. The term “proximal” refers the position of an element closer to the human or robotic operator of the surgical instrument and further away from the surgical end effector of the surgical instrument. The term “distal” refers to the position of an element closer to the surgical end effector of the surgical instrument and further away from the human or robotic operator of the surgical instrument.

I. Surgical Instrument with Gate Scarring for Tracking

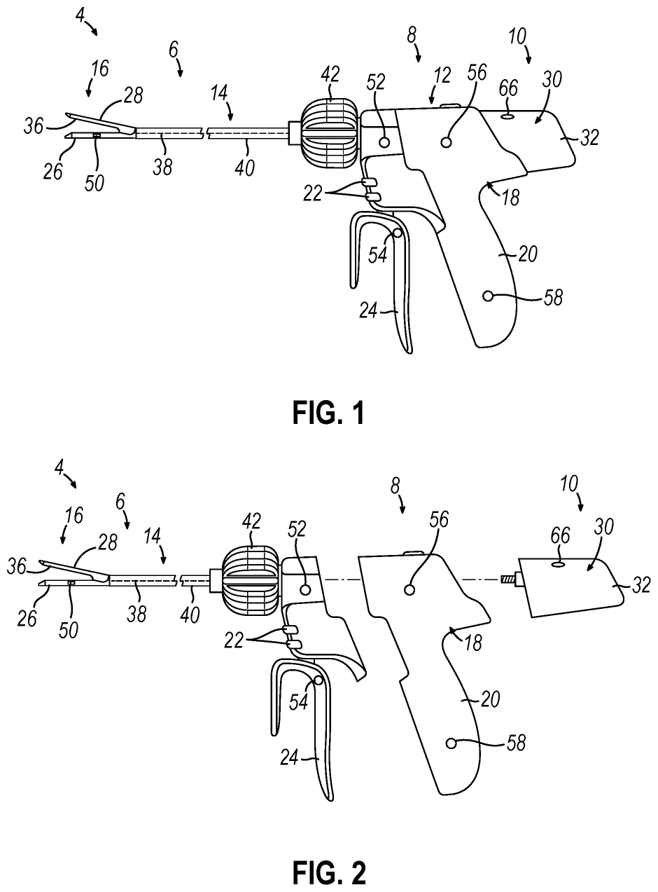

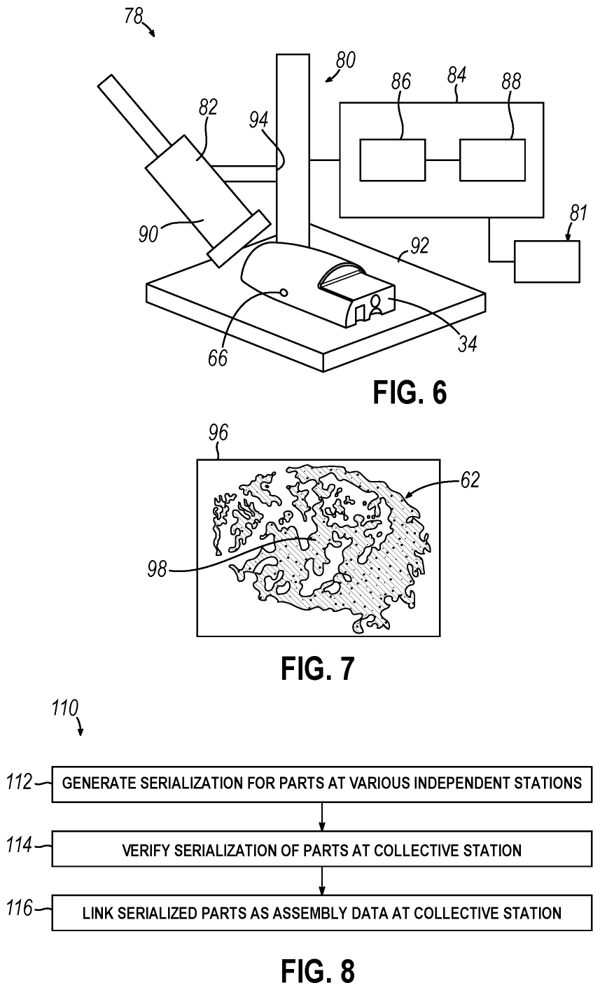

FIGS. 1-5B show a surgical instrument (4) and a method of manufacturing surgical instrument (4) for tracking without the inclusion of additional identifiers dedicated to such tracking of one or more portions of surgical instrument (4). In this respect, the manufacturing process forms a unique identifier already present on surgical instrument (4) such that at least one party to a supply chain of surgical instrument (4) serializes this unique identifier via a registration system, such as a registration system shown in FIGS. 6-9. Surgical instrument (4), discussed below in greater detail, includes many such component parts and associated assemblies that include unique identifiers for initial serialization and later verification for tracking. In particular, these component parts include one or more gate scars from formation by injection molding that act as a part “fingerprint,” unique to that particular part for serialization. Injection molding materials, such as metal or plastic, into parts thus provides features for serialization as discussed below in greater detail.

The following provides an example of part registration and serialization in the context of an ultrasonic surgical instrument (4) via gate scars; however, it will be appreciated that any surgical instrument bearing such features as gate scars via manufacturing may be similarly serialized. The invention is thus not intended to be unnecessarily limited to the manufacture of ultrasonic surgical instrument (4).

### A. Exemplary Surgical Instrument

FIG. 1 shows an exemplary surgical instrument, such as ultrasonic surgical instrument (4). At least part of instrument (4) may be constructed and operable in accordance with at least some of the teachings of any of the various patents, patent application publications, and patent applications that are cited herein. As described therein and as will be described in greater detail below, instrument (4) is operable to cut tissue and seal or weld tissue (e.g., a blood vessel, etc.) substantially simultaneously.

Instrument (4) of the present example shown in FIGS. 1-2 may also be referred to as an instrument assembly (4) and comprises a distal sub-assembly (6), an intermediate sub-assembly (8), and a proximal sub-assembly (10). Intermediate sub-assembly (8) includes a handle assembly (12), whereas distal sub-assembly (6) includes a shaft assembly (14) and an end effector (16) distally extending from shaft assembly (14). Handle assembly (12) has a body (18) including a pistol grip (20), and shaft assembly (14) has a pair of buttons (22) and a trigger (24) that is pivotable toward and away from pistol grip (20) when assembled as instrument assembly (4). It should be understood, however, that various other suitable configurations may be used, including but not limited to a scissor grip configuration. End effector (16) includes an ultrasonic blade (26) and a pivoting clamp arm (28). Clamp arm (28) is coupled with trigger (24) such that clamp arm (28) is pivotable toward ultrasonic blade (26) in response to pivoting of trigger (24) toward pistol grip (20); and such that clamp arm (28) is pivotable away from ultrasonic blade (26) in response to pivoting of trigger (24) away from pistol grip (20). Various suitable ways in which clamp arm (28) may be coupled with trigger (24) will be apparent to those of ordinary skill in the art in view of the teachings herein. In some versions, one or more resilient members are used to bias clamp arm (28) and/or trigger (24) to the open position shown in FIG. 1.

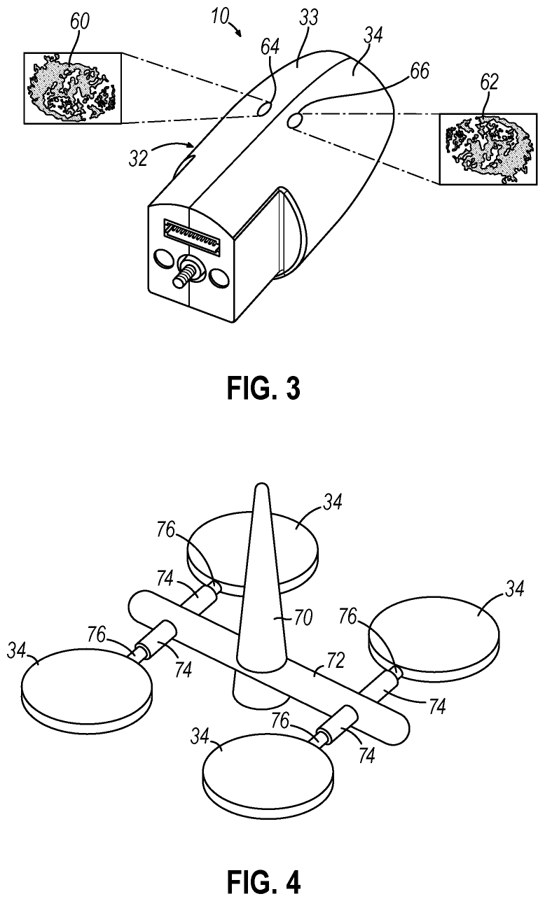

Proximal sub-assembly (10) shown in FIGS. 1-2 includes an ultrasonic transducer assembly (30) positioned within a proximal housing (32) having housing parts (33, 34) (see FIG. 3). Transducer assembly (30) couples with a generator (not shown) such that transducer assembly (30) receives electrical power from generator (not shown). More particularly, piezoelectric elements in transducer assembly (30) convert electrical power from generator (not shown) into ultrasonic vibrations. Generator (not shown) may include a power source and control module that is configured to provide a power profile to transducer assembly (30) that is particularly suited for the generation of ultrasonic vibrations through transducer assembly (30). By way of example only, generator (not shown) may comprise a GEN04 or GEN11 sold by Ethicon Endo-Surgery, Inc. of Cincinnati, Ohio. In addition, or in the alternative, generator (not shown) may be constructed in accordance with at least some of the teachings of U.S. Pub. No. 2011/0087212, entitled “Surgical Generator for Ultrasonic and Electrosurgical Devices,” published Apr. 14, 2011, the disclosure of which is incorporated by reference herein. It should also be understood that at least some of the functionality of generator (not shown) may be integrated into instrument (4) and may even include a battery or other on-board power source. Still other suitable forms that generator (not shown) may take, as well as various features and operabilities that generator (not shown) may provide, will be apparent to those of ordinary skill in the art in view of the teachings herein. In an exemplary arrangement, distal, intermediate, and proximal assemblies (6, 8, 10) are coupled together to form instrument (4) and used to perform a surgical procedure. Assemblies (6, 8, 10) may then be decoupled, such as for further processing.

End effector (16) comprises clamp arm (28) and ultrasonic blade (26) as discussed briefly above. Clamp arm (28) includes a clamp pad (36), which faces blade (26). Clamp arm (28) is pivotable toward and away from blade (26) to selectively compress tissue between clamp pad (36) and blade (26). More particularly, blade (26) is an integral feature of a distal end of an acoustic waveguide (38), which extends coaxially through at least one tube (40) of shaft assembly (14), and which is configured to communicate ultrasonic vibrations to blade (26).

Shaft assembly (14) comprises an outer tube (40) and an inner tube (not shown). Outer tube (40) is operable to translate longitudinally relative to inner tube (not shown) to selectively pivot clamp arm (28) toward and away from blade (26). It should be understood that clamp arm (28) may be pivoted back away from blade (26) by translating outer tube (40) distally relative to inner tube (not shown). In an exemplary use, clamp arm (28) may be pivoted toward blade (26) to grasp, compress, seal, and sever tissue captured between clamp pad (36) and blade (26). Clamp arm (28) may also be pivoted away from blade (26) to release tissue from between clamp pad (36) and blade (26); and/or to perform blunt dissection of tissue engaging opposing outer surfaces of clamp arm (28) and blade (26). In some alternative versions, inner tube (not shown) translates while outer tube (40) remains stationary to provide pivotal movement of clamp arm (28).

As shown in FIGS. 1-2, shaft assembly (14) of the present example extends distally from handle assembly (12). A rotation control assembly (41) has a rotation control member in the form of rotation control knob (42), which is secured to a proximal portion of outer tube (40). Knob (42) is rotatable relative to body (18), such that shaft assembly (14) is rotatable about the longitudinal axis defined by outer tube (40), relative to handle assembly (12). Such rotation may provide rotation of end effector (16) and shaft assembly (14) unitarily, which also includes unitary rotation of acoustic waveguide (38) coupled with transducer assembly (30) within handle assembly (12). In some other versions, various rotatable features may simply be omitted and/or replaced with alternative rotatable features, if desired. While the present shaft assembly (14) is generally rigid and linear, it will be appreciated that alternative shaft assemblies may include an articulation section (not shown) for deflecting end effector (16) at various lateral deflection angles relative to a longitudinal axis defined by outer tube (40). It will be appreciated that such an articulation section may take a variety of forms. Various other suitable forms that an articulation section may take will be apparent to those of ordinary skill in the art in view of the teachings herein.

Waveguide (38) extends proximally through knob (42) and into body (18) to mechanically couple with transducer assembly (30). When waveguide (38) is sufficiently coupled with transducer assembly (30), ultrasonic vibrations that are generated by transducer assembly (30) are communicated along waveguide (38) to reach blade (26). In the present example, the distal end of blade (26) is located at a position corresponding to an anti-node associated with resonant ultrasonic vibrations communicated through waveguide (38), in order to tune the acoustic assembly to a preferred resonant frequency fₒ when the acoustic assembly is not loaded by tissue. When transducer assembly (30) is energized, the distal end of blade (26) is configured to move longitudinally in the range of, for example, approximately 10 to 500 microns peak-to-peak, and in some instances in the range of about 20 to about 200 microns at a predetermined vibratory frequency fₒ of, for example, 55.5 kHz. When transducer assembly (30) of the present example is activated, these mechanical oscillations are transmitted through waveguide (38) to reach blade (26), thereby providing oscillation of blade (26) at the resonant ultrasonic frequency. Thus, when tissue is secured between blade (26) and clamp pad (36), the ultrasonic oscillation of blade (26) may simultaneously sever the tissue and denature the proteins in adjacent tissue cells, thereby providing a coagulative effect with relatively little thermal spread. In some versions, an electrical current may also be provided through blade (26) and/or clamp pad (36) to also seal the tissue.

### B. Injection Molded Gate Scarring

In addition to various parts and assemblies of surgical instrument (4) discussed above, each part formed via injection molding further includes a gate scar with a respective surface discontinuity that differs from a surrounding surface. With respect to FIGS. 2 and 3, such gate scars of the present example include, but are not limited to, blade scar (50) on metal injection molded ultrasonic blade (26), shaft scar (52) on plastic injection molded shaft assembly (14), trigger scar (54) on plastic injection molded trigger (24), body scar (56) on plastic injection molded body (18), grip scar (58) on plastic injection molded pistol grip (20), and proximal housing scars (64, 66) on respective housing parts (33, 34) of proximal housing (32). Each of gate scars (50, 52, 54, 56, 58, 64, 66) with associated surface discontinuities is unique amongst each other and different from all other gate scars and, in this respect, is an identifier unique to each part as formed, such as housing parts (33, 34) with unique surface discontinuities (60, 62) of proximal housing scars (64, 66) shown in FIG. 3.

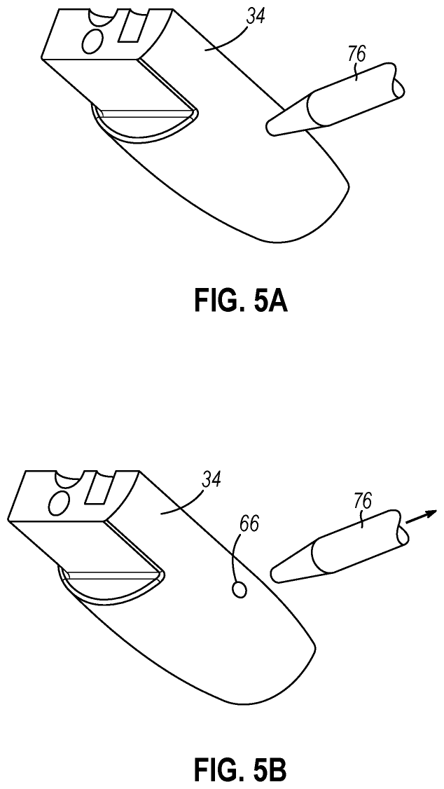

To this end, formation of gate scars occurs during an injection molding process, such as injection molding housing part (34). With respect to FIG. 4, during injection molding, a sprue (70) receives a material, such as plastic or metal, and the material feeds through a main runner (72) and branch runners (74) as desired until passing through gates (76) and into a plurality of housing parts (34) to harden. Even if housing parts (34) are functionally the same for use in one or more instruments (4), each gate (76) connected at a respective housing part (34) forms a unique surface discontinuity (62) of gate scar (66) when gate (76) breaks free of housing part (34) as shown in FIGS. 5A-5B. Again, any such part may be molded of material, such as metal or plastic, so as to have a gate scar for serialization as discussed below, and the invention is not intended to be unnecessarily limited to injection molding of proximal housing part (34) as discussed above.

### II. Tracking Parts and Assemblies of a Surgical Instrument

In view of the unique gate scar, such as proximal housing scar (66) with surface discontinuity (62), a supplier of housing part (34), or other party to the supply chain, serializes housing part (34) with a registration system (80). In one example, registration system (80) includes an imaging device (82) operatively connected to a controller (84) having a microprocessor (86) and a memory (88). Imaging device (82) shown in FIG. 6 includes a digital camera (90), a part stand (92), and a camera mount (94) configured to secure camera (90) relative to part stand (92).

Imaging device (82) is communicatively coupled to microprocessor (86) and transmits image data to microprocessor (86), as will be described in more detail below. Microprocessor (86) may be embodied as any type of processor capable of performing the functions described herein. For example, microprocessor (86) may be embodied as a single or multi-core processor, a digital signal processor, a microprocessor, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or other processor or processing/controlling circuit or controller.

Microprocessor (86) is also communicatively coupled to a wireless communication module (not shown) that facilitates wireless communication with a console (not shown) via any of a variety of wireless communication protocols such as, for example, Wi-Fi, Cellular, or Wireless Personal Area Networks (WPAN) (e.g., IrDA, Bluetooth, Bluetooth Low Energy, Zigbee, wireless USB). Controller (84) may additionally or alternatively be configured to support wired communication via a communication port (not shown), such as a USB port, for example. The console (not shown) may receive a message from wireless communication module (not shown) and facilitate generation of a notification to a user of imaging device (82). By way of example only, the console may include a data processor and a display that cooperate to generate the notification. Various suitable forms that a console for imaging device (82) may take will be apparent to those skilled in the art in view of the teachings herein.

With respect to FIGS. 6 and 7, imaging device (82) is configured to photograph proximal housing scar (66) as a digital image (96). Microprocessor (86) applies an algorithm to digital image (96) to detect surface discontinuity (62) within proximal housing scar (66) and process surface discontinuity (62) to create an identifier (98) based on the metrology of surface discontinuity (62). More particularly, identifier (98) represents the metrology data of surface discontinuity (62) saved to memory (88) as a unique serialization of proximal housing part (34) for future retrieval, comparison, and data linkage between an upstream, independent station (78) with one registration system (80) and a downstream, collection section (81) with another registration system (80) discussed below in greater detail.

With continued reference to FIGS. 6 and 7, FIG. 8 shows an overview of a method (110) of tracking a part, such as housing part (34), during an assembly process in the supply chain. Method (110) generally includes generating serialization for each component part of surgical instrument (4) at a respective, independent station (78) of registration system (80) in step (112). In one example, each manufacturer of each respective component part utilizes an independent station (78) of registration system (80), although some manufacturers may share such stations of registration system (80) if desired. Still, in the example of housing part (34), the manufacturer of housing part (34) serializes housing part (34) via housing scar (66). Following serialization, housing part (34) is shipped to another downstream manufacturer for assembly with additional parts, such as housing part (33) (see FIG. 3). In particular, this downstream manufacturer then, in a step (114), utilizes a collective station (81) with another registration system (80) to verify serialization of all parts to be assembled, including housing part (34), to ensure parts are accurately identifiable. Finally, the downstream manufacturer links data associated with each part in an assembly in a step (116), such as linking data of housing part (33) to data of housing part (34) in the formation of proximal housing (32) (see FIG. 3). The linked data of parts to assemblies is then saved to for future retrieval, comparison, and data linkage and may be repeated with each assembly for tracking assemblies of surgical instrument (4) and associated parts.

Again with reference to FIGS. 6 and 7, FIG. 9 shows method (110) of tracking a part, such as housing part (34), in greater detail with generating serialization of parts at independent stations (78) in step (112) further including steps (118, 120, 122, 124, 126, 128). To this end, after injection molding housing part (34) and breaking gate (76) (see FIG. 4), the manufacturer identifies surface discontinuity (62) of proximal housing scar (66) and sets housing part (34) on part stand (92) of independent station (78) of registration system (80) in a step (118). Imaging device (82) then photographs proximal housing scar (66) to form digital image (96) in a step (120). Microprocessor (86), as briefly discussed above, applies an algorithm to digital image (96) to detect surface discontinuity (62) within proximal housing scar (66) in a step (122). Next, in a step (124), microprocessor (86) processes digital image (96) of surface discontinuity (62) into a first processed image. Microprocessor (86), in a step (126), then creates an identifier (98) based on imaged metrology data of surface discontinuity (62) and saves identifier (98) to a structure query language (SQL) database in memory (88) thereby effectively serializing housing part (34).

To further assemble one or more portions of surgical instrument (4), other parts and assemblies, including housing part (34), move downstream through the supply chain and are gathered by another manufacturer for assembly. This downstream manufacturer verifies serialization for each of these parts and/or assemblies for identification as briefly discussed above in step (114), which further includes steps (128, 130, 132, 134, 136). More particularly, in a step (128), the downstream manufacturer identifies surface discontinuity (62) of proximal housing scar (66) and sets housing part (34) on part stand (92) of collection station (81) of another registration system (80). Imaging device (82) at collection station (81) then photographs proximal housing scar (66) to form digital image (96) in a step (130). Microprocessor (86), as briefly discussed above, applies an algorithm to digital image (96) to detect surface discontinuity (62) within proximal housing scar (66) in a step (132). Next, in a step (134), microprocessor (86) processes digital image (96) of surface discontinuity (62) into a second processed image. Microprocessor (86) then retrieves identifier (98) of metrology from memory (88) created upstream at independent station (78) and compares this second processed image from step (134) to identifier (98) at collection station (81) in a step (136) for part verification. On one hand, should the second processed image not match identifier (98), then housing part (34) may be discarded from the supply chain at step (136). On the other hand, should the second processed image match identifier (98) in step (136), then housing part (34) is positively identified and prepared or being digitally linked in SQL database in memory (88) with other parts to form assembly data in step (116), such as housing part (33) (see FIG. 4), and physically assembled for further manufacturing.

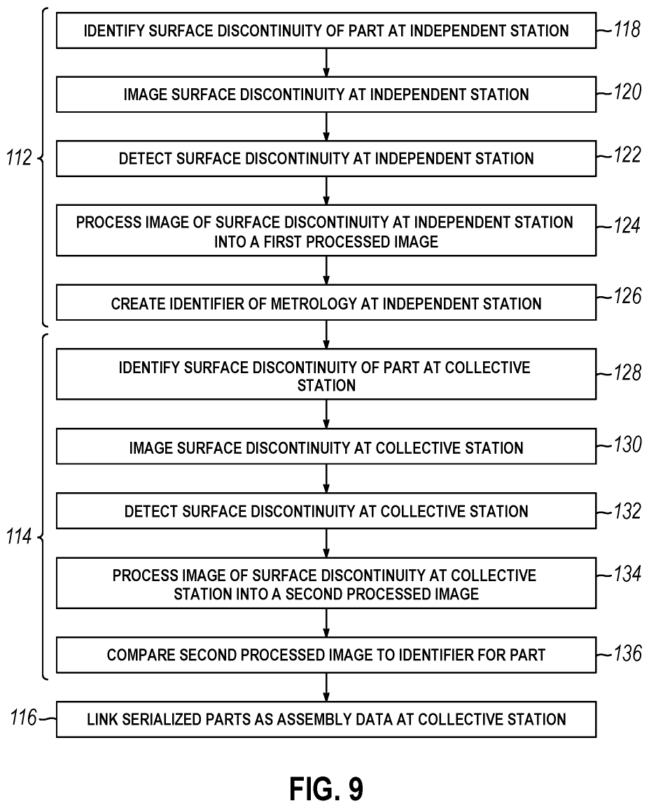

The above description of method (110) shown in FIGS. 8 and 9 for tracking parts and/or assemblies through the supply chain enables such tracking based on gate scars, such as gate scars (50, 52, 54, 56, 58, 64, 66), without the inclusion of additional identifiers. While the above description particularly described digitally linking housing parts (33, 34) in memory (88) (see FIG. 6) to form at least a portion of ultrasonic transducer assembly (30), it will be appreciated that any parts, assemblies, and/or portions of surgical instrument (4) may be linked as desired. The invention is thus not intended to be unnecessarily limited to tracking housing parts (33, 34) shown in the present example.

### III. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method of tracking at least a portion of a surgical instrument (4), comprising: (a) imaging a surface discontinuity (60, 62) on the at least the portion of the surgical instrument (4) into a first digital image (96) at a first station (78), wherein the surface discontinuity (60, 62) is positioned within a gate scar (64, 66) formed from injection molding of the at least the portion of the surgical instrument (4); and (b) processing the first digital image (96) into a first processed image for tracking the at least the portion of the surgical instrument (4).

### Example 2

The method of Example 1, further comprising: creating a first identifier (98) based on the first processed image thereby serializing the at least the portion of the surgical instrument (4) as a first serialized part (33, 34).

### Example 3

The method of Example 2, further comprising: verifying serialization of the first serialized part (33, 34) at a second station (81).

### Example 4

The method of Example 3, wherein verifying serialization of the first serialized part (33, 34) further includes: imaging the surface discontinuity (60, 62) on the at least the portion of the surgical instrument (4) into a second digital image (96) at the second station (81).

### Example 5

The method of Example 4, wherein verifying serialization of the first serialized part (33, 34) further includes: processing the second digital image (96) into a second processed image for further tracking the at least the portion of the surgical instrument (4).

### Example 6

The method of Example 5, wherein verifying serialization of the first serialized part (33, 34) further includes: comparing the second processed image from the first station (78) to the first identifier (98).

### Example 7

The method of any one or more of Examples 3 through 6, further comprising: linking the first serialized part (33, 34) with a second serialized part (33, 34) as a first assembly (32) in a memory (88).

### Example 8

The method of Example 7, further comprising linking the first assembly with a second assembly (12) in the memory (88).

### Example 9

The method of any one or more of Examples 1 through 8, further comprising detecting the surface discontinuity (60, 62) in the first digital image (96).

### Example 10

The method of any one or more of Examples 1 through 9, wherein the at least the portion of the surgical instrument (4) is formed of a metal material.

### Example 11

The method of any one or more of Examples 1 through 9, wherein the at least the portion of the surgical instrument (4) is formed of a plastic material.

### Example 12

The method of any one or more of Examples 1 through 11, further comprising injection molding material to form the at least the portion of the surgical instrument (4).

### Example 13

The method of any one or more of Examples 1 through 12, further comprising removing a gate (76) from the at least the portion of the surgical instrument (4) thereby forming the gate scar (64, 66).

### Example 14

The method of any one or more of Examples 1 through 13, wherein the surgical instrument (4) is an ultrasonic surgical instrument (4).

### Example 15

The method of any one or more of Examples 1 through 14, wherein the at least the portion of the surgical instrument (4) is an ultrasonic blade (26).

### Example 16

A method of tracking at least a portion of a surgical instrument, comprising: (a) injection molding material to form the at least the portion of the surgical instrument; (b) removing a gate (76) from the at least the portion of the surgical instrument (4) thereby forming a gate scar (64, 66); (c) imaging a surface discontinuity (60, 62) on the at least the portion of the surgical instrument (4) into a first digital image (96) at a first station (78), wherein the surface discontinuity (60, 62) is positioned within the gate scar (64, 66) formed from injection molding of the at least the portion of the surgical instrument (4); (d) detecting the surface discontinuity (60, 62) in the first digital image (96); and (e) processing the first digital image (96) into a first processed image for tracking the at least the portion of the surgical instrument (4).

### Example 17

The method of Example 16, wherein the at least the portion of the surgical instrument (4) is formed of a metal material.

### Example 18

The method of Example 17, wherein the at least the portion of the surgical instrument (4) is an ultrasonic blade (26).

### Example 19

The method of Example 16, wherein the at least the portion of the surgical instrument (4) is formed of a plastic material.

### Example 20

The method of claim 16, further comprising: (a) creating a first identifier (98) based on the first processed image thereby serializing the at least the portion of the surgical instrument (4) as a first serialized part (33, 34); (b) imaging the surface discontinuity (60, 62) on the at least the portion of the surgical instrument (4) into a second digital image (96) at a second station (81); (c) processing the second digital image (96) into a second processed image for further tracking the at least the portion of the surgical instrument (4); (d) comparing the second processed image from the first station (78) to the first identifier (98); and (e) linking the first serialized part (33, 34) with a second serialized part (33, 34) as a first assembly (32) in a memory (88).

### IV. Miscellaneous

It should be understood that any of the versions of instruments described herein may include various other features in addition to or in lieu of those described above. By way of example only, any of the instruments described herein may also include one or more of the various features disclosed in any of the various references that are incorporated by reference herein. It should also be understood that the teachings herein may be readily applied to any of the instruments described in any of the other references cited herein, such that the teachings herein may be readily combined with the teachings of any of the references cited herein in numerous ways. Moreover, those of ordinary skill in the art will recognize that various teachings herein may be readily applied to electrosurgical instruments, stapling instruments, and other kinds of surgical instruments. Other types of instruments into which the teachings herein may be incorporated will be apparent to those of ordinary skill in the art.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Versions of the devices described above may have application in conventional medical treatments and procedures conducted by a medical professional, as well as application in robotic-assisted medical treatments and procedures. By way of example only, various teachings herein may be readily incorporated into a robotic surgical system such as the DAVINCI™ system by Intuitive Surgical, Inc., of Sunnyvale, California. Similarly, those of ordinary skill in the art will recognize that various teachings herein may be readily combined with various teachings of U.S. Pat. No. 6,783,524, entitled “Robotic Surgical Tool with Ultrasound Cauterizing and Cutting Instrument,” published Aug. 31, 2004, the disclosure of which is incorporated by reference herein.

Versions described above may be designed to be disposed of after a single use, or they can be designed to be used multiple times. Versions may, in either or both cases, be reconditioned for reuse after at least one use. Reconditioning may include any combination of the steps of disassembly of the device, followed by cleaning or replacement of particular pieces, and subsequent reassembly. In particular, some versions of the device may be disassembled, and any number of the particular pieces or parts of the device may be selectively replaced or removed in any combination. Upon cleaning and/or replacement of particular parts, some versions of the device may be reassembled for subsequent use either at a reconditioning facility, or by a user immediately prior to a procedure. Those skilled in the art will appreciate that reconditioning of a device may utilize a variety of techniques for disassembly, cleaning/replacement, and reassembly. Use of such techniques, and the resulting reconditioned device, are all within the scope of the present application.

By way of example only, versions described herein may be sterilized before and/or after a procedure. In one sterilization technique, the device is placed in a closed and sealed container, such as a plastic or TYVEK bag. The container and device may then be placed in a field of radiation that can penetrate the container, such as gamma radiation, x-rays, or high-energy electrons. The radiation may kill bacteria on the device and in the container. The sterilized device may then be stored in the sterile container for later use. A device may also be sterilized using any other technique known in the art, including but not limited to beta or gamma radiation, ethylene oxide, or steam.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1-15. (canceled)

16. A method of tracking at least a portion of a surgical instrument, comprising:
(a) imaging a surface discontinuity on the at least the portion of the surgical instrument into a first digital image at a first station, wherein the surface discontinuity is positioned within a gate scar-formed from injection molding of the at least the portion of the surgical instrument; and
(b) processing the first digital image into a first processed image for tracking the at least the portion of the surgical instrument.

17. The method of claim 16, further comprising: creating a first identifier based on the first processed image thereby serializing the at least the portion of the surgical instrument as a first serialized part.

18. The method of claim 17, further comprising: verifying serialization of the first serialized part at a second station.

19. The method of claim 18, wherein verifying serialization of the first serialized part further includes: imaging the surface discontinuity on the at least the portion of the surgical instrument into a second digital image at the second station.

20. The method of claim 19, wherein verifying serialization of the first serialized part further includes: processing the second digital image into a second processed image for further tracking the at least the portion of the surgical instrument.

21. The method of claim 20, wherein verifying serialization of the first serialized part further includes: comparing the second processed image from the first station to the first identifier.

22. The method of claim 18, further comprising: linking the first serialized part with a second serialized part as a first assembly in a memory.

23. The method of claim 22, further comprising linking the first assembly with a second assembly in the memory.

24. The method of claim 16, further comprising detecting the surface discontinuity in the first digital image.

25. The method of claim 16, wherein the at least the portion of the surgical instrument is formed of a metal material.

26. The method of claim 16, wherein the at least the portion of the surgical instrument is formed of a plastic material.

27. The method of claim 16, further comprising injection molding material to form the at least the portion of the surgical instrument.

28. The method of claim 16, further comprising removing a gate from the at least the portion of the surgical instrument thereby forming the gate scar.

29. The method of claim 16, wherein the surgical instrument is an ultrasonic surgical instrument.

30. The method of claim 16, wherein the at least the portion of the surgical instrument is an ultrasonic blade.

31. A method of tracking at least a portion of a surgical instrument, comprising:
(a) injection molding material to form the at least the portion of the surgical instrument;
(b) removing a gate from the at least the portion of the surgical instrument thereby forming a gate scar;
(c) imaging a surface discontinuity on the at least the portion of the surgical instrument into a first digital image at a first station, wherein the surface discontinuity is positioned within the gate scar formed from injection molding of the at least the portion of the surgical instrument;
(d) detecting the surface discontinuity in the first digital image; and
(e) processing the first digital image into a first processed image for tracking the at least the portion of the surgical instrument.

32. The method of claim 31, wherein the at least the portion of the surgical instrument is formed of a metal material.

33. The method of claim 32, wherein the at least the portion of the surgical instrument is an ultrasonic blade.

34. The method of claim 31, wherein the at least the portion of the surgical instrument is formed of a plastic material.

35. The method of claim 31, further comprising:
(a) creating a first identifier based on the first processed image thereby serializing the at least the portion of the surgical instrument as a first serialized part;
(b) imaging the surface discontinuity on the at least the portion of the surgical instrument into a second digital image at a second station;
(c) processing the second digital image into a second processed image for further tracking the at least the portion of the surgical instrument;
(d) comparing the second processed image from the first station to the first identifier; and
(e) linking the first serialized part with a second serialized part as a first assembly in a memory.
